(19) United States
(12) Patent Application Publication
(10) Pub. No.: US 2014/0000159 A1
(43) Pub. Date: Jan. 2, 2014

(54) CASCADE WATER SUPPLY STRUCTURE OF PLANTS

(71) Applicant: Tien-Yin CHAN, Tainan City (TW)

(72) Inventor: Tien-Yin CHAN, Tainan City (TW)

(21) Appl. No.: 13/536,044

(22) Filed: Jun. 28, 2012

(51) Int. Cl. A01G 29/00; A01G 27/02

(52) U.S. Cl. 47/48.5

(57) ABSTRACT

The present invention is a cascade water supply structure of plants, including plural aqueducts, wherein at least one aqueduct is connected to a water supply end. Besides, the porous bodies are provided in soil close to roots of the plants and the porous bodies are connected in cascade by the aqueducts. The porous bodies are collaboratively provided in a receiving unit which is installed on an outer wall of a building. By the aqueducts, water from the water supply end is guided into each porous body and is permeated into soil by the capillary action of the porous bodies, allowing soil to keep humid constantly that the plants can be grown without being watered for a long time, saving manpower and cost.

### BACKGROUND OF THE INVENTION

a) Field of the Invention

The present invention relates to a cascade water supply structure of plants, and more particularly to a cascade water supply structure, wherein aqueducts are used to connect each porous body in cascade, so that the capillary effect of the porous body can be utilized to continuously permeate water required by plants, achieving a function of growing the plants without watering them for a long time.

b) Description of the Prior Art

To beautify environment, an outer wall of a house will always be provided with a plant growing device. In early times, plant pots are arranged to grow the plants. However, to use the plant pots, the plants must be watered everyday, especially that as the plant pots contain less water, excessive water will overflow easily, so that mosses will be grown at places where water drips down and thus the effect of utilization is inferior.

Accordingly, the Taiwan Utility Model Patent, No. M394340, “Greening Vegetation Wall,” publicized on Dec. 11, 2010, discloses a wall including at least a wall surface which is provided with at least an embedded base; a water tank which is provided at a top rim of the wall, with that a side of the water tank is provided with a window and a bottom of the water tank is provided with at least a porthole; at least a pot which is provided in the embedded base of the wall, with that the pot is provided with an outer casing to enclose a porous inner casing, a sealed water storage space is formed between the outer casing and the porous inner casing and the outer casing is provided with a connection hole penetrating into the water storage space; and at least a tube which is provided inside the wall, with that the tube is connected to the porthole of the water tank and the connection hole of the pot. Nevertheless, this kind of structure can only provide for arranging the plant pots and a range of plant growing is limited that the plants need to be watered periodically, spending manpower considerably.

Additionally, the Taiwan Utility Model Patent, No. M402678, “Flower Stand with a Porous Water Tube,” publicized on May 1, 2011, discloses a flower stand containing a body which includes at least a plant growing space; at least a water storage unit which is assembled with the body and includes a water storage space; and at least a porous piping which is assembled in the plant growing space of the body, with that a flow path is connected to the water storage space of the water storage unit. The absorption and permeation of the porous piping are utilized to keep soil humid, which facilitates watering the plants stably. However, this kind of structure is unable to expand the range of plant growing and is only suitable for a small area, such as a balcony. Therefore, the value of landscaping reduces significantly.

### SUMMARY OF THE INVENTION

Accordingly, the primary object of the present invention is to provide a cascade water supply structure of plants. The cascade water supply structure is provided with plural aqueducts, with that at least one aqueduct is connected to a water supply end; plural porous bodies which are provided in soil close to roots of plants. The abovementioned porous bodies are connected in cascade by the plural aqueducts and by the aqueducts, water provided by the water supply end is guided to each porous body, so that water can be transported into soil by the porous bodies.

The abovementioned porous body is a hollow porous tube and an interior of the porous body is formed with a flow channel.

The present invention is further provided with a receiving unit which is used to load soil for growing the plants. The receiving unit contains at least one porous body.

The aforementioned receiving unit is a plant pot or a flower stand.

The aforementioned receiving unit is a C-shaped corrugated tube.

A bottom of the aforementioned C-shaped corrugated tube is provided axially with two limiting members and the abovementioned porous bodies are axially provided between the two limiting members.

An outer rim of the abovementioned receiving unit is axially provided with a fixing portion. An interior of the fixing portion is axially transfixed with a support element which is transfixed with at least a fixing member to fix the support element on a wall.

The outer rim of the abovementioned receiving unit is bonded with plural clamps. The clamps are fixed on a wall by at least one fixing member.

The abovementioned water supply end is a water source with pressure.

The abovementioned water supply end is a water storage vessel.

A control valve is provided between the abovementioned water supply end and the aqueducts.

The present invention further includes a multi-way tube which is used to connect the abovementioned aqueducts or porous bodies.

The present invention is provided with following advantages:
1. The aqueducts and the porous bodies can be connected in cascade freely, so that the water supply path can be flexible.
2. As being released slowly by the capillary action of the porous bodies, water or nutrient solution can be used completely for irrigation. Therefore, for the plants, the supply of water or nutrient solution will not be excessive or insufficient.
3. Supplying water by the capillary action of the porous bodies allows soil that is used to grow the plants to keep properly humid all the time, which helps growing the plants and avoids spending manpower to water the plants for a long time.
4. The C-shaped corrugated tube of the present invention can be installed on an outer wall of a building and can be arranged and assembled by various patterns, in association with the growth of various plants. Therefore, a vegetation wall in a large area can be formed to result in effects of greening and beautification.
5. For the vegetation wall, the present invention can supply water at a constant amount without watering the plants too much that water will overflow to wet pedestrians by forming water drips, flushing soil to lose or growing mosses as the vegetation wall is too humid.
6. The present invention can effectively save water consumption to reduce water usage significantly. Therefore, the manufacturing price is cheap and the cost can be reduced.
7. As long as that the water supply end can supply sufficient water, each plant in the water supply path can be watered for a long time, which can be managed rather conveniently and can effectively reduce the cost of management and caring for growing the plants in a large area.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of the present invention.

FIG. 2 shows a cutaway view of the present invention, wherein the porous bodies and aqueducts are assembled together.

FIG. 3 shows a schematic view of the present invention installed on an outer wall of a building.

FIG. 4 shows a schematic view of usage, when the present invention is used to grow plants.

FIG. 5 shows a schematic view of the receiving unit that is fixed on an outer wall of a building, according to the present invention.

FIG. 6 shows a top view of the present invention using the multi-way tube to connect each aqueduct and porous body to divert flow direction of water.

### DETAILED DESCRIPTION OF THE PREFERRED EMBODIMENTS

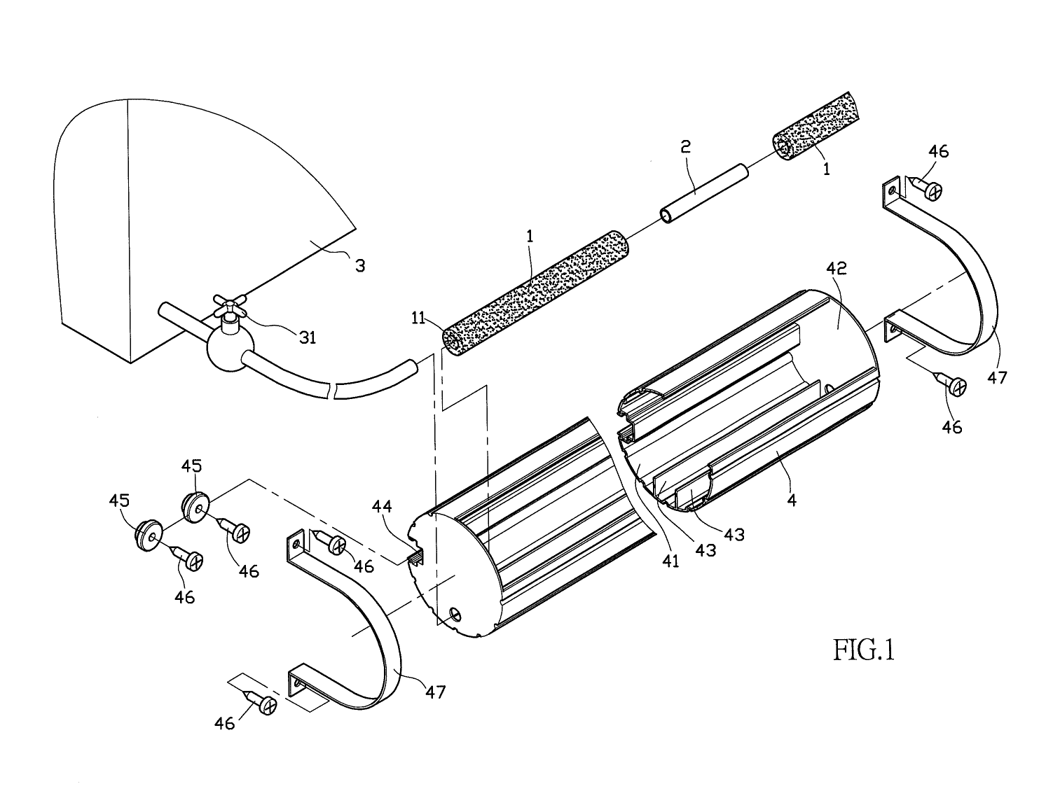

Referring to FIG. 1, the embodiment of the present invention comprises plural porous bodies 1, plural aqueducts 2, a water supply end 3 and a receiving unit 4, wherein the porous body 1 is made by a porous material and is a hollow porous tube, with that an interior of the porous body 1 is formed with a hollow flow channel 11.

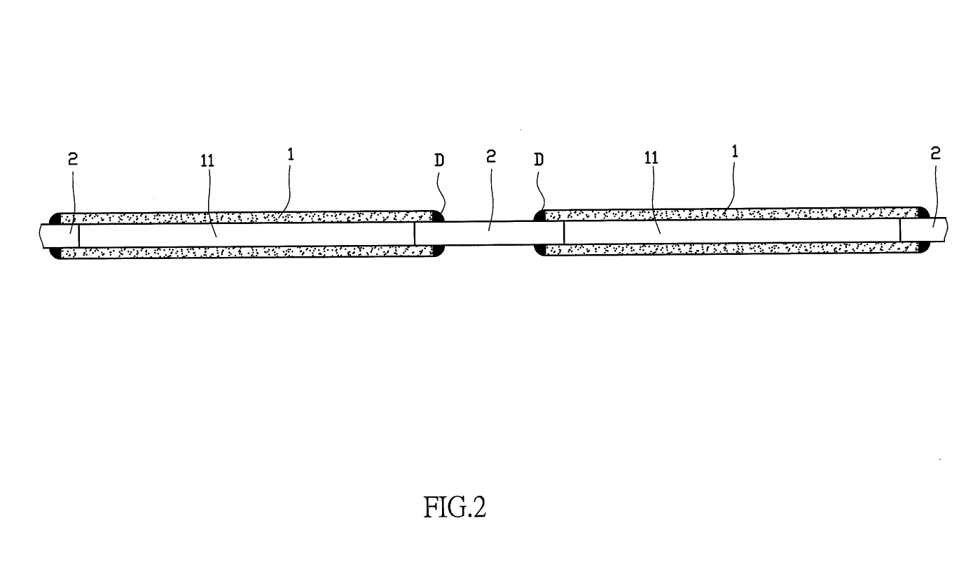

Each aqueduct 2 is connected in cascade between two porous bodies 1 (as shown in FIG. 2), and two ends of the aqueduct 2 are sealed respectively with a sealant D or an adhesive agent at the flow channel 11 of each porous body 1.

The water supply end 3 is connected to the aqueduct 2 and can be a water tank, a water storage vessel of a water tower or a water source with pressure, such as a tap water faucet in a home. In addition, a control valve 31 is provided between the water supply end 3 and the aqueducts 2. The control valve 31 can be a manual type or an electronic type to be able to turn on or shut off water supply in time, manually or automatically.

The receiving unit 4 provides for installing the porous bodies 1 and the aqueducts 2. The receiving unit 4 can be a plant pot, a flower stand or a C-shaped corrugated tube. An interior of the receiving unit 4 is concaved with a slot 41 and the receiving unit 4 is provided with an opening 42 to connect with the slot 41. A bottom of the receiving unit 4 is axially provided with two opposite limiting members 43 and an outer rim at a rear side of the receiving unit 4 is axially provided with a fixing portion 44. An interior of the fixing portion 44 is axially transfixed with a support element 45 which can be transfixed with at least a fixing member 46. The support element 45 is fixed on an outer wall of a building by the fixing member 46, which in turn allows the receiving unit 4 to be fixed on the outer wall. Besides, an outer rim of the receiving unit 4 can be also bonded with clamps 47 which can be fixed on the outer wall of the building by the fixing member 46, as well. However, there are many known methods of fixing the receiving unit 4 on the outer wall and the present invention is not limited to the abovementioned two methods.

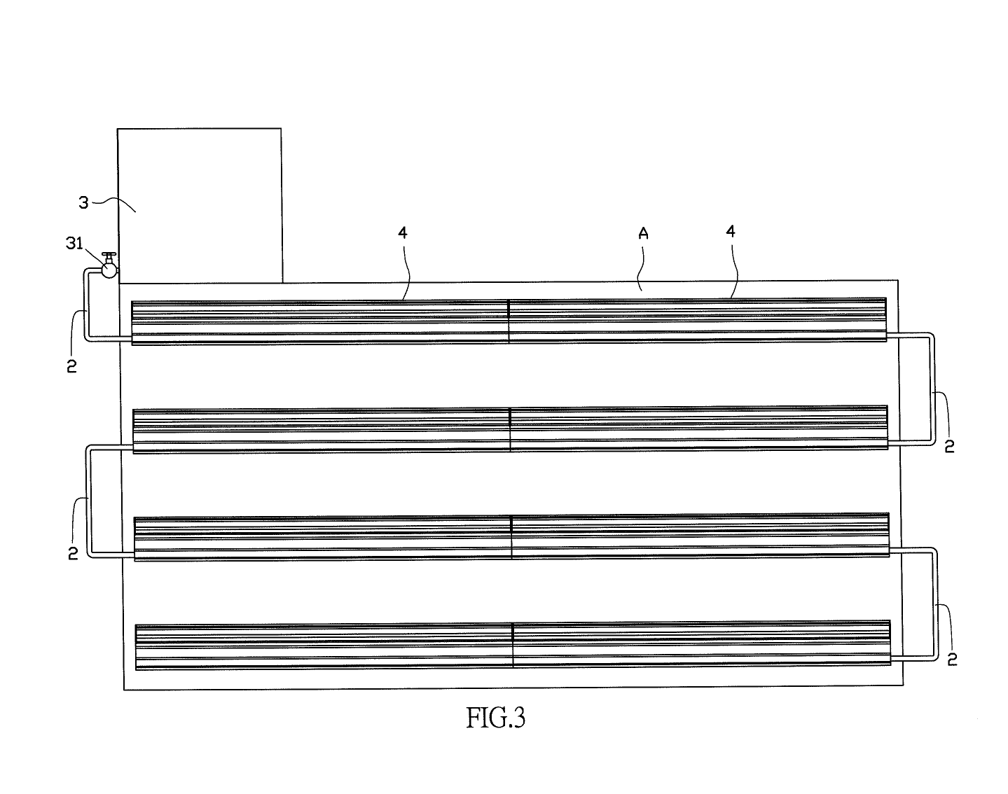

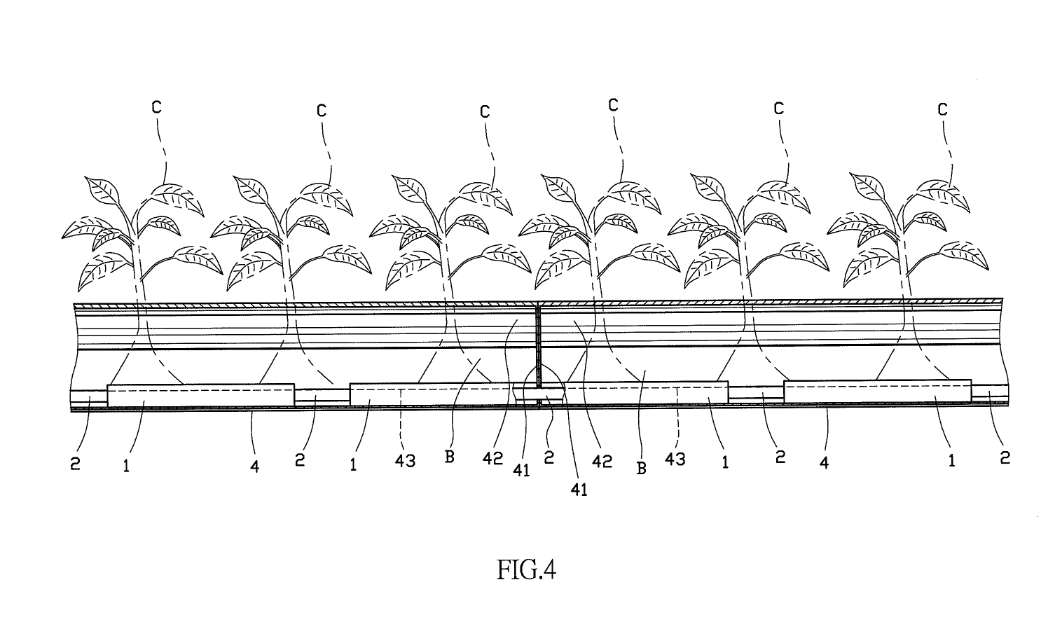

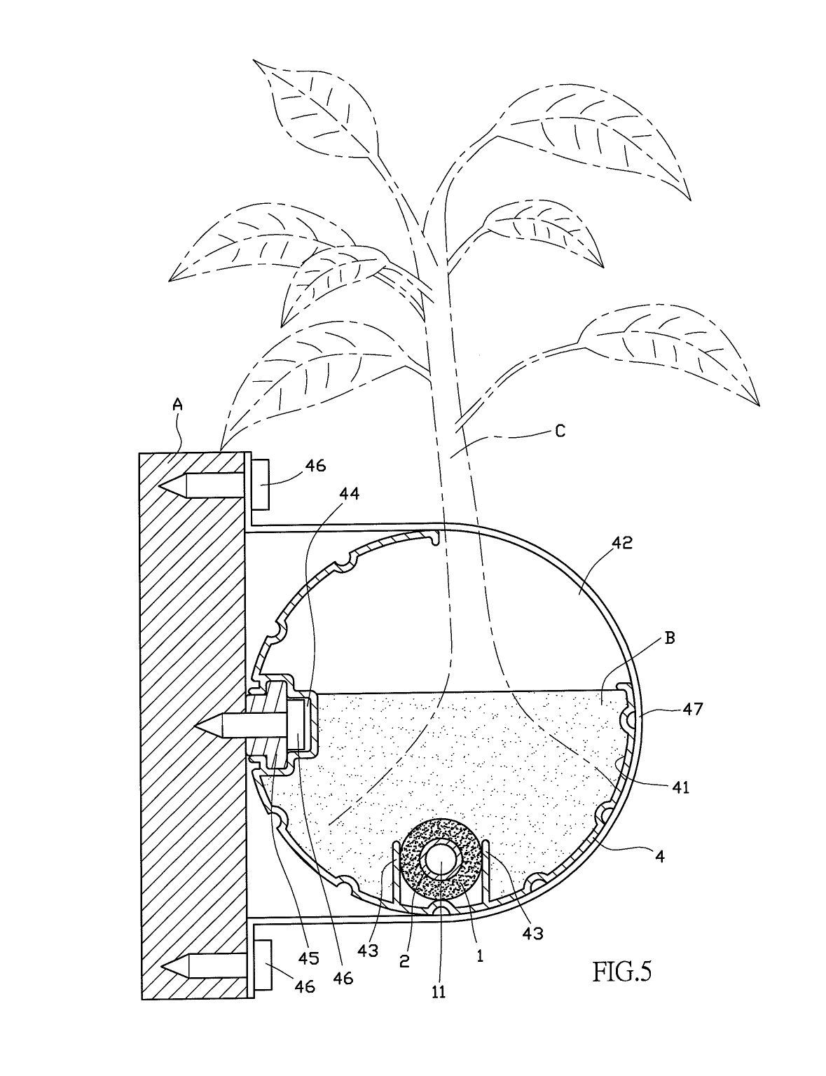

Referring to FIG. 3 and FIG. 4, when installing, the support element 45 is first fixed on an outer wall A of a building by the plural fixing members 46 (as shown in FIG. 5) and the porous bodies 1 are connected one by one in cascade by the aqueducts 2. Next, the porous bodies 1 are emplaced axially between the two opposite limiting members 43 of the receiving unit 4, so that the porous bodies 1 will not move freely after being positioned. In addition, the receiving unit 4 is also transfixed by the aqueducts 2 and then the porous bodies 1 are connected in cascade, followed by using the sealant D or the adhesive agent to seal the connection places between the porous bodies 1 and the aqueducts 2 (as shown in FIG. 2), so as to prevent from water leaking. On the other hand, the aqueduct 2 at the most front end is connected to the water supply end 3 at a higher place of the building, so as to guide water from the water supply end 3. In addition, the porous body 1 at the tail end of the aqueduct 2 is sealed to prevent from water leaking. Next, the fixing portion 44 at the rear side of the receiving unit 4 is transfixed axially on the support element 45. The outer rim of the receiving unit 4 is bonded with the plural clamps 47 and the clamps 47 are fixed on the outer wall A by the fixing members 46, so that the receiving unit 4 can be fixed on the outer wall A. Finally, an interior of the slot 41 of the receiving unit 4 is poured with a filler B which can be culture dirt or soil, and then an interior of the filler B is planted with plants C and roots of the plants C are made to close to the porous bodies 1.

When using the present invention, the control valve 31 is turned on manually or automatically, and using the pressure resulted from the water supply end 3 at the higher place, water can be transported through the aqueducts 2 into the flow channel 11 of each porous body 1 to flow. Using the capillary action of the porous body 1, water from the aqueduct 2 can be transported and permeated slowly into the filler B, allowing the roots of the plants C close to the filler B to absorb water slowly for a long time. By the capillary action of the porous body 1 to supply water, the filler B can be kept humid constantly, which benefits the growth of the plants C. By controlling the degree of opening of the control valve 31 manually or automatically, the amount of water supply can be controlled. Therefore, the plants can be watered for a long time without using manpower. The control valve 31 can be even turned off during a rainy season to save water effectively. The abovementioned plants C can grow outward from the opening 42 of the receiving unit 4 and spread over the entire outer wall A, forming a vegetation wall to promote greening, heat dissipation and beautification of the building.

In the abovementioned embodiment, even the control valve 31 is turned on constantly, as the porous bodies 1 supply water slowly by the capillary action, water will not be transported to the filler B in a large quantity to waste water.

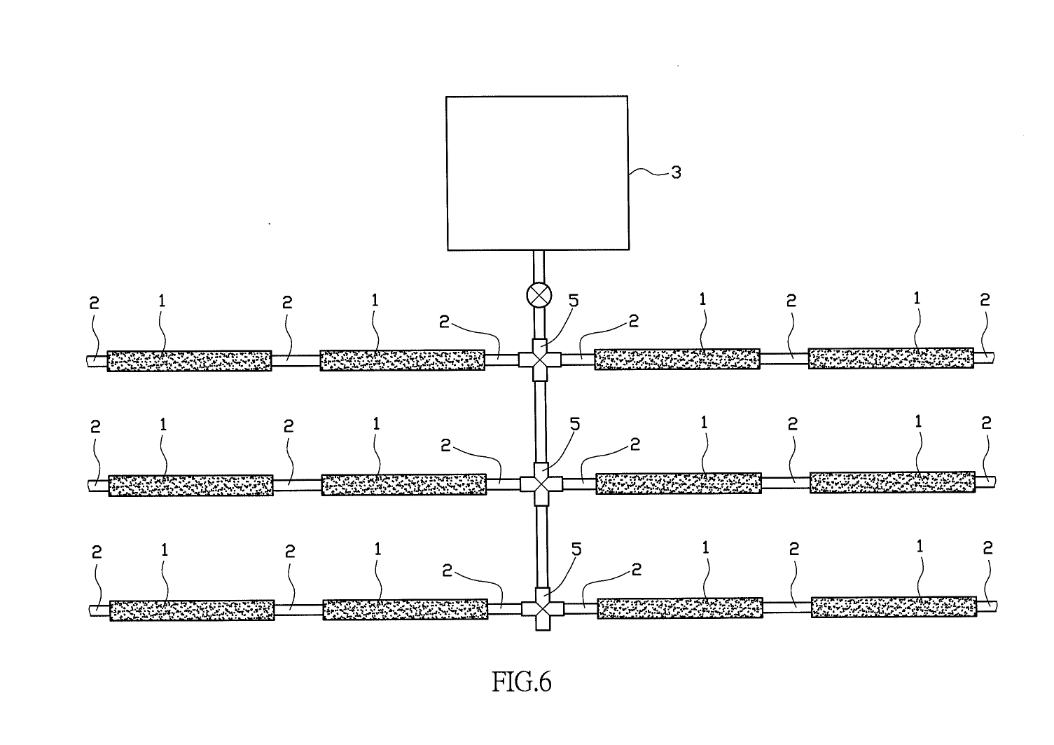

For an open space of plant growing, such as a yard or a farm, the plants are not grown in the receiving unit 4 but are grown directly in soil on a ground. The present invention can apply too; for the open space of plant growing, the porous bodies 1 of the present invention are provided in soil close to a root of each plant and each porous body 1 is then connected in cascade by the aqueduct 2. Thus, water of the water supply end can provide to each plant sufficiently. As shown in FIG. 6, a multi-way tube 5 is used to connect the abovementioned aqueducts 2 or the porous bodies 1 to divert flow direction of the water. Allowing a plane height of the water supply end 3 to be higher than those of the aqueducts 2 and the porous bodies 1, a gravity of water itself is utilized to transport water equally to each porous body 1, thereby forming water supply in a large area.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A cascade water supply structure of plants, comprising:
plural aqueducts, wherein at lest one aqueduct is connected to a water supply end; and
plural porous bodies, which are provided in soil close to roots of plants, such that the porous bodies are connected in cascade by the aqueducts;
water that is supplied by the water supply end being guided by the plural aqueducts to each porous body, thereby allowing water to be transported into soil by the porous bodies.

2. The cascade water supply structure of plants, according to claim 1, wherein the porous body is a hollow porous tube and an interior of the porous body is formed with a flow channel.

3. The cascade water supply structure of plants, according to claim 1, further comprising a receiving unit to load soil for growing the plants, such that receiving unit contains at least one porous body.

4. The cascade water supply structure of plants, according to claim 3, wherein the receiving unit is a plant pot or a flower stand.

5. The cascade water supply structure of plants, according to claim 3, wherein the receiving unit is a C-shaped corrugated tube.

6. The cascade water supply structure of plants, according to claim 5, wherein a bottom of the C-shaped corrugated tube is axially provided with two limiting members and the porous bodies are axially provided between the two limiting members.

7. The cascade water supply structure of plants, according to claim 3, wherein an outer rim of the receiving unit is axially provided with a fixing portion, an interior of the fixing portion is axially transfixed with a support element, such that the support element is transfixed with at least a fixing member to fix the support element on a wall.

8. The cascade water supply structure of plants, according to claim 3, wherein the outer rim of the receiving unit is bonded with plural clamps and the clamps are fixed on a wall by at least a fixing member.

9. The cascade water supply structure of plants, according to claim 1, wherein the water supply end is a water source with pressure.

10. The cascade water supply structure of plants, according to claim 1, wherein the water supply end is a water storage vessel.

11. The cascade water supply structure of plants, according to claim 1, wherein a control valve is provided between the water supply end and the aqueducts.

12. The cascade water supply structure of plants, according to claim 1, further comprising a multi-way tube, such that the multi-way tube is connected to the aqueducts or porous bodies.
